(19) United States
(12) Patent Application Publication
(10) Pub. No.: US 2010/0284779 A1
(43) Pub. Date: Nov. 11, 2010

(54) Loading Method And Apparatus For Loading

(76) Inventor: Peter Thorneycroft, Birmingham (GB)

Correspondence Address: HODGSON RUSS LLP;THE GUARANTY BUILDING, 140 PEARL STREET, SUITE 100, BUFFALO, NY, 14202-4040, US

(21) Appl. No.: 12/743,894

(22) PCT Filed: Nov. 7, 2008
(86) PCT No.: PCT/GB08/51038

§ 371 Date: May 20, 2010

(30) Foreign Application Priority Data
Nov. 21, 2007 (GB) 0722808.3

(51) Int. Cl. A61G 3/02; B65G 47/00

(52) U.S. Cl. 414/813; 414/800

(57) ABSTRACT

A loading method and apparatus for loading is described which is a particular utility in loading wheelchairs (w) and the like into the vehicles. A flexible web (20) of material supports the item to be loaded during the loading process. This aids the user (u), as the user can grasp the web (20) rather than the item (w) to be loaded. Furthermore, the user (u) can support the weight of the item (w) to be loaded while maintaining good posture and observing good manual handling practice throughout the loading process.

### FIELD OF THE INVENTION

The present invention relates to loading methods and apparatus for loading. In particular, but not exclusively the present invention relates to loading methods and apparatus suitable for use in the manual loading of items such as wheelchairs into the load space of vehicles.

### BACKGROUND TO THE INVENTION

Two main problems arise in loading. Firstly, the item to be loaded has to be grasped or otherwise held/supported to allow loading to take place. Secondly the weight of the item has to be overcome. A very large number of mechanical apparatus have been devised to address these problems. However, there is a requirement for a device of simple, low cost construction which facilitates the loading process in applications such as the loading of an item such as a wheelchair into the load space of a vehicle.

### SUMMARY OF THE INVENTION

It is an aim of example embodiments of the present invention to address at least one problem associated with the prior art, whether identified herein or otherwise.

In a first aspect the present invention provides a loading method comprising the steps of:

(a) providing a loading web with a first end portion;
(b) securing the first end portion of the loading web in a load space;
(c) placing an item to be loaded on to the loading web; and
(d) manually applying tension to the loading web to thereby urge the item to be loaded towards the load space.

Suitably, the loading web provided in step (a) comprises a second end portion, and the step (d) comprises applying tension to the second end portion. Suitably, the step (d) comprises manually grasping the loading web at or near to the second end portion.

Suitably, the step (a) further comprises providing securement means for the loading web. Suitably, the securement means provided at step (a) are provided at the first end portion of the loading web. Suitably, the securement means is employed in the step (b). Suitably, the securement means provided in step (a) comprises one or more load space engaging portions. Suitably, the securement means comprises two load space engaging portions. Suitably, the securement means provided in step (a) comprises a load space spanning member. Suitably, the securement means provided in step (a) comprises load space engaging portions provided at end portions of the load space spanning member. Suitably, the securement means provided in step (a) comprises a load space spanning member in the form of a pole. Suitably, the securement means provided in step (a) comprises an expanding pole. Suitably, the securement means provided in step (a) comprises a spring-loaded pole. Suitably, the securement means provided in step (a) comprises friction enhancing end portions for engaging internal walls of a load space.

Suitably, the friction enhancing end portions comprise caps. Suitably, the caps comprise a rubber or plastics material.

Suitably, the step (b) comprises engaging the securement means with one or more internal surfaces of the load space. Suitably, the step (b) comprises engaging end portions of the securement means with internal surfaces of the load space. Suitably, the step (b) comprises engaging the securement means with the load space by a frictional coupling. Suitably, the step (b) comprises engaging the securement means with the load space by an interference fit. Suitably, the step (b) comprises engaging the securement means with one or more securement features provided in the load space.

Suitably, the loading web provided at step (a) comprises a web of flexible sheet material. Suitably, the loading web provided at step (a) comprises a textile sheet material. Suitably, the loading web provided at step (a) is approximately rectangular, with edge dimensions of at least 1 m by 2 m. Suitably, the loading web provided at step (a) comprises one or more grip portions to aid grasping thereof by a user when applying tension to the loading web. Suitably, the loading web provided at step (a) comprises one or more grip portions at the second end thereof. Suitably, the loading web provided at step (a) comprises grip portions wherein the or each grip portion comprises a cut out portion in the loading web. Suitably, the loading web provided at step (a) comprises a loading portion proximate to the first end portion and a grip portion proximate to the second end portion. Suitably, the loading portion comprises a substantially unbroken sheet. Suitably, the grip portion comprises a broken sheet. Suitably, the grip portion comprises a net.

Suitably, the method comprises a method of loading inanimate objects. Suitably, the method comprises a wheelchair loading method, and the step (c) comprises placing a wheelchair on the loading web.

Suitably, the step (c) further comprises placing a rigid element on the loading web to facilitate loading.

Suitably, the step (c) comprises placing a rigid element on the loading web between the load space and the item to be loaded.

Suitably, the rigid element is substantially smooth.

Suitably, the rigid element has an effective width at least as great as the width of the item to be loaded. Suitably, the rigid element has an effective width at most as great as the width of the load space.

Suitably, the rigid element is made up of one or more boards or one or more board-like sections. Suitably, the effective width of the rigid element is determined by the separation of the board-like sections when placed on the loading web. Suitably, the step (c) further comprises coupling the rigid element to the loading web. Suitably, the loading web provided at step (a) comprises rigid element fixing means, to in use fix the rigid element to the loading web.

Suitably, the step (d) further comprises manually grasping the loading web. Suitably, the step (d) comprises manually grasping the loading web at a grip portion provided on the loading web. Suitably, the step (d) comprises applying tension to the loading web proximate to a second end thereof. Suitably, the step (d) of applying tension to the loading web comprises applying tension to the loading web at a portion of the loading web beyond the item to be loaded, in a direction away from the load space. Suitably, the step (d) of applying tension to the loading web comprises applying tension to the loading web at a portion of the loading web beyond the item to be loaded, in a direction away from the load space, thereby urging the item to be loaded up and toward the load space. Suitably, the step (d) of applying tension to the loading web comprises raising the second end portion above the level of the securement means, and/or above the level of the first end portion. Suitably, the step (d) of applying tension to the loading web comprises raising the second end portion to a position whereby it is grasped by the user and the user's back is straight, before tension applied to the loading web moves the item to be loaded from its place as established at step (c). Suitably, the step (d) of applying tension to the loading web comprises moving the second end portion away from the load space. Suitably, the step (d) of applying tension to the loading web initially causes the weight of the item to be loaded to be partially supported on an edge portion of the load space. Suitably, the step (d) of applying tension to the loading web causes the item to be loaded to rotate from an upright configuration to a laid-down configuration. Suitably, the step (d) of applying tension to the loading web causes the item to be loaded to rotate about an axis perpendicular to the direction of tension applied to the loading web. Suitably, the step (d) of applying tension to the loading web causes the item to be loaded to rotate about a horizontal axis. Suitably, the step (d) of applying tension to the loading web causes the item to be loaded to rotate away from the second end of the loading web. Suitably, the step (d) of applying tension to the loading web causes the item to be loaded to rest on and rotate about an edge portion of the load space. Suitably, the step (d) of applying tension to the loading web causes the item to be loaded to rest on the rigid element during loading. Suitably, the step (d) of applying tension to the loading web causes the item to be loaded to slide along the loading web or to slide along the rigid element as the item to be loaded moves toward the load space. Suitably, the step (d) of applying tension to the loading web causes the item to be loaded to slide toward the load space, and/or to slide into or to drop into the load space.

In a second aspect there is provided a loading apparatus as provided in step (a) of the first aspect.

### BRIEF INTRODUCTION TO THE DRAWINGS

For a better understanding of the invention, and to show how embodiments of the same may be carried into effect, reference will now be made, by way of example, to the accompanying diagrammatic drawings in which:

FIG. 1 shows the component parts of a loading apparatus according to a first example embodiment of the present invention;

FIG. 2 shows the apparatus of FIG. 1 secured in a load space; and

FIG. 3 shows the apparatus of FIG. 1 in use.

### DESCRIPTION OF EXAMPLE EMBODIMENTS

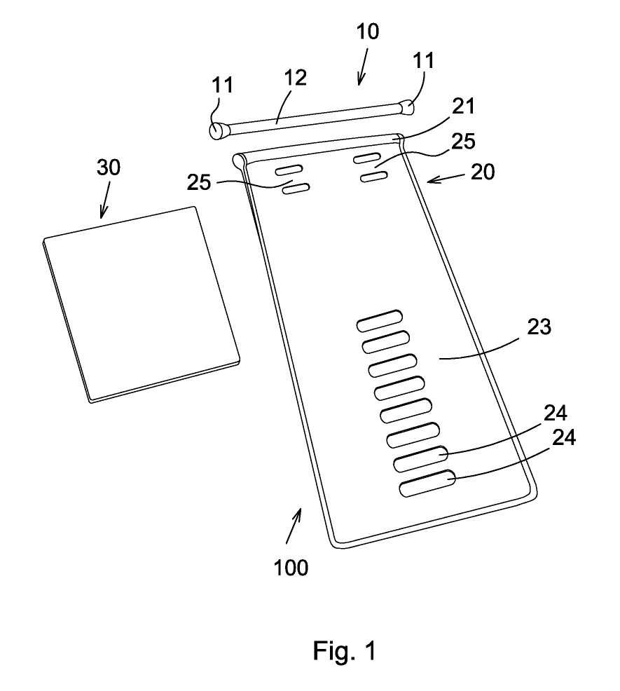

FIG. 1 shows a loading apparatus 100 comprising a securement means 10 coupled to a loading web 20, and a rigid element in the form of a board 30.

To use the loading apparatus 100 a user first secures the securement means 10 in a load space with the loading web 20 extending from the securement means 10. The loading web 20 rests on the ground near to the load space. An item to be loaded is placed on the loading web 20. A user applies tension to the loading web 20 by manually grasping the web and pulling generally up and/or away from the securement means 10. The tension on the loading web 20 raises the loading web 20 and accordingly raises the item to be loaded. The user can conveniently complete the loading process by further raising/extending the loading web 20 and allowing the item to be loaded to slide into the load space.

In example embodiments the board 30 is positioned on the loading web 20 between the item to be loaded and the load space. In use the board 30 helps the item to be loaded to slide into the load space, by preventing the item to be loaded from snagging on the edge of the load space. The board 30 also serves to provide a protective interface between the item to be loaded and the load space. In the embodiment shown in FIG. 1, the board 30 may be replaced by two smaller boards or runners. These runners may conveniently be fixed to the loading web 20 using rigid element fixing means 25. The rigid element fixing means 255 comprise paired apertures defined in the loading web through which runners may be threaded in such a way that tension in the loading web 20 serves to hold the runners in place.

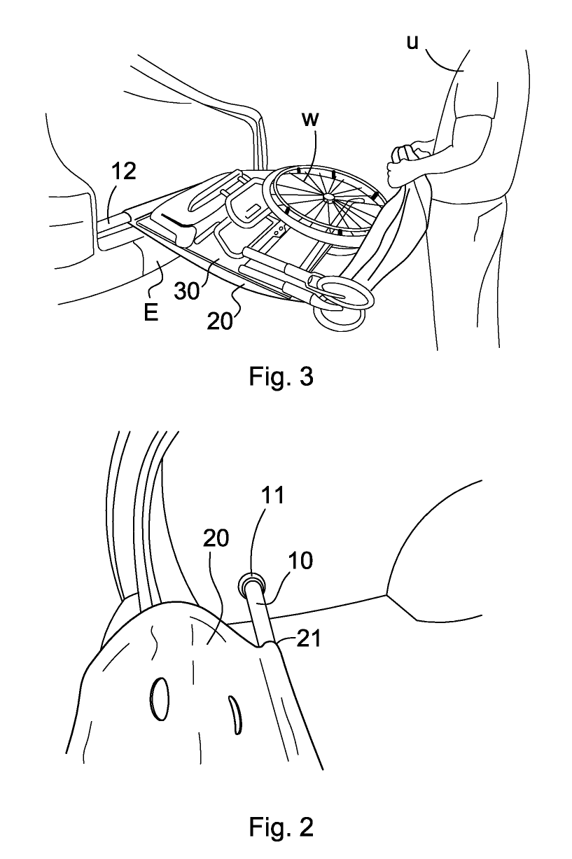

The apparatus shown in FIG. 1 is shown in use in FIGS. 2 and 3. FIGS. 2 and 3 will now be referred to in a detailed explanation of the loading apparatus 100 and its use in a loading method.

FIG. 2 shows the securement means 10 is attached to the loading web 20 at a first end portion 21 of the loading web 20. The securement means 10 in the example embodiments shown comprises an expanding spring loaded pole 12 which can conveniently secure the loading apparatus in a load space by pressing against opposed interior surfaces of the load space. In this example the load space comprises the boot of a car.

The expanding spring loaded pole 12 conveniently secures the apparatus 100 in a load space without having to be an exact fit for the load space, due to its expandability. This makes the securement means 10 adaptable for use in different load spaces. The securement means 10 is easily fixed and also easily removed from the load space if required. Furthermore the expanding spring loaded pole 12 does not require any modification to the load space in order to provide a secure fixing.

The strength of fixing provided by the securement means 10 is enhanced by the use of end caps 11. The end caps 11 comprises a rubber material, and serve to increase the frictional contact force between the securement means 10 and the interior surfaces of the load space. The end caps provide an increased contact area between the securement means 10 and the interior surfaces of the load space, compared to the cross sectional area provided by the pole 12. In example embodiments the end caps 11 also provide a textured surface to further increase the frictional contact force.

The loading web 20 comprises a flexible sheet material, in the example embodiment shown a sheet of woven textile material. The loading web 20 is approximately rectangular, with edge dimensions of approximately 1.5 m by 3 m. Grip portions 24 are provided at a second end portion 23 to aid grasping of the loading web 20 by a user. In the example embodiment shown, the grip portions 24 comprise cut-outs in the loading web 20.

The board 30 is a smooth element to help the item to be loaded to slide over the loading web 20 and to form a protective barrier between the item to be loaded and the load space.

As mentioned above, once the loading web 20 has been secured in the load space, a second end portion of the loading web 20 is extended away from the load space, typically lying on the ground. The item to be loaded, shown in FIG. 3 as a wheelchair W is placed on the loading web 20. The board 30 is placed on the loading web 20 between the load space and the item to be loaded.

A user U then grips the second end portion 23 proximate to a free end of the loading web 20, for example using the grip portions 24. The user raises the loading web 20 and pulls it taut, such as to a position in which the tension in the loading web 20 is insufficient to raise the item to be loaded from the ground. At this point the user has a straight back, a posture that can be maintained throughout the rest of the loading process as the item to be loaded moves from its rest position.

The user U now has two options, which can be performed either separately or simultaneously. Firstly, the user U can use his/her arms to further raise the loading web 20. Secondly, the user can move away from the load space. Each of these actions serves to tension the web and to thereby lift the item to be loaded from the ground. There is a tendency, due to the angle of the loading web 20 relative to the item to be loaded, for the item to be loaded to rotate toward the load space. Further lifting of the web/further movement away from the load space by the user U urges the item to raise up and rotate towards the load space. The item to be loaded will slide toward and then into the load space once the loading web 20 has been sufficiently raised by the user U. During part of the loading process the item to be loaded will perhaps rest in a position in which it is partially supported on an edge portion E of the load space. In these circumstances the item to be loaded may conveniently rotate about the edge portion E of the load space during part of the loading process.

The loading apparatus described, and the associated loading process lends themselves to load bearing in a way which the user U can maintain good posture, and use large muscle groups to move the item to be loaded. The loading apparatus is of low cost, and of simple construction. The loading apparatus can easily be fitted to a wide range of vehicles, without the need for modification to vehicle load space. Once in place the loading apparatus is generally unobtrusive, but can be easily removed and stored if required.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A loading method comprising the steps of:
(a) providing a loading web with a first end portion;
(b) securing the first end portion of the loading web in a load space;
(c) placing an item to be loaded on to the loading web; and
(d) manually applying tension to the loading web to thereby urge the item to be loaded towards the load space.

2-3. (canceled)

4. The method of claim 1, wherein the step (a) further comprises providing securement means for the loading web, and wherein the securement means is employed in the step (b).

5-8. (canceled)

9. The method of claim 4, wherein the securement means provided in step (a) comprises a load space spanning member.

10-11. (canceled)

12. The method of claim 4, wherein the securement means provided in step (a) comprises an expanding pole.

13-16. (canceled)

17. The method of claim 4, wherein the step (b) comprises engaging the securement means with one or more internal surfaces of the load space by a frictional coupling.

18-25. (canceled)

26. The method of claim 1, wherein the loading web provided at step (a) comprises one or more grip portions to aid grasping thereof by a user when applying tension to the loading web.

27. (canceled)

28. The method of claim 26, wherein the loading web provided at step (a) comprises one or more grip portions, and wherein each grip portion comprises a cut out portion in the loading web.

29. The method of claim 1, wherein the loading web provided at step (a) comprises a loading portion comprising a substantially unbroken sheet, and, wherein the loading web provided at step (a) comprises a loading portion proximate to a first end portion and a grip portion proximate to a second end portion.

30-33. (canceled)

34. The method of claim 1, wherein the method comprises a wheelchair loading method, and the step (c) comprises placing a wheelchair on the loading web.

35. The method of claim 1, wherein the step (c) further comprises placing a rigid element on the loading web to facilitate loading.

36. The method of claim 35, wherein the step (c) comprises placing a rigid element on the loading web between the load space and the item to be loaded.

37. The method of claim 35, wherein the rigid element placed on the loading web between the load space and the item to be loaded is substantially smooth, to facilitate sliding of the item to be loaded on the rigid element.

38-45. (canceled)

46. The method of claim 1, wherein the step (d) of applying tension to the loading web comprises applying tension to the loading web at a portion of the loading web beyond the item to be loaded, in a direction away from the load space, thereby urging the item to be loaded up and toward the load space.

47. (canceled)

48. The method of claim 1, wherein the step (d) of applying tension to the loading web comprises raising the second end portion to a position whereby it is grasped by the user and the user's back is straight, before tension applied to the loading web moves the item to be loaded from its place as established at step (c).

49-54. (canceled)

55. The method of claim 1, wherein the step (d) of applying tension to the loading web causes the item to be loaded to be supported by and rotate about an edge portion of the load space.

56-62. (canceled)
